(19) United States
(12) Patent Application Publication
(10) Pub. No.: US 2002/0036826 A1
(43) Pub. Date: Mar. 28, 2002

(54) Diffraction surfaces and methods for the manufacture thereof

(75) Inventors: Peter Leigh-Jones, Vermont (AU); Brian Frederick Alexander, Wantirna (AU); Peter Samuel Atherton, North Sydney (AU)

Correspondence Address: FITCH EVEN TABIN AND FLANNERY, 120 SOUTH LA SALLE STREET, SUITE 1600, CHICAGO, IL, 60603-3406, US

(73) Assignee: Mikoh Technology Limited

(21) Appl. No.: 09/782,830

(22) Filed: Feb. 14, 2001

Related U.S. Application Data
(63) Continuation of application No. 09/018,727, filed on Feb. 4, 1998, now abandoned.
Application No. 09/018,727 is a division of application No. 08/700,541, filed on Aug. 27, 1996, now abandoned.

(30) Foreign Application Priority Data
Feb. 28, 1994 (AU) PM4155
Jun. 22, 1994 (AU) PM6411
Jul. 5, 1994 (AU) PM6631
Sep. 5, 1994 (AU) PM7942
Sep. 26, 1994 (AU) PM8376

(51) Int. Cl. G02B 5/18; G02B 27/42; G02B 27/44

(52) U.S. Cl. 359/558; 359/566; 359/567

(57) ABSTRACT

A diffraction surface and a method of making the surface. The surface may be applied to labels and other items to identify the origin of the goods to which the label is attached. The surface can include a block grating including ridges and recesses in the enclosed squares or rectangles. The diffraction grating manufactured by processing a data stream indicative of the image including obtaining a Fourier Transform of the data stream and preferably clipping and quantising the data stream, and deforming a plate surface in accordance with the data stream. Also claimed is a diffraction grating having spaced first and second portions each producing an image on a receiving surface in response to illumination by a reading light beam, configured such that when the reading light beam moves from the first to the second portion, a change occurs in the first image to produce the second image.

### TECHNICAL FIELD

The present invention relates to the production of projected images from an optically diffractive surface. These images may be confirmed either visually or by machine in order to authenticate the optical surface or for other purposes such as data storage or entertainment.

### BACKGROUND OF THE INVENTION

A current problem is the sale of counterfeit goods. Counterfeiting is often inhibited by the use of labels and trademarks. However unauthorised use of the labels and trademarks is difficult to prevent.

The above problems are discussed in International Application PCT/AU92/00252.

### OBJECT OF THE INVENTION

It is the object of the present invention to overcome or substantially ameliorate the above problems.

### SUMMARY OF THE INVENTION

There is disclosed herein a layer having a diffraction surface to provide one or more diffracted light beams when illuminated by a reading light beam, said surface including first surface area portions dispersed with second area portions, said surface having a base plane with said first area portions being spaced from said base plane by a distance different to that of the second area portions, the first area portions also having a width extending generally parallel to the plane of the diffraction surface, which width is less than the wavelength of the reading light beam, and wherein when illuminated. the diffraction beam produced will provide a recognisable image on an intercepting surface.

Preferably, said diffraction surface would have a base plane, with first area portions being spaced from said base plane by a greater distance than said second area portions. It is still further preferred that said first area portions are curved so as to be convex. Therefore, said first area portions are generally ridges adjacent to said second area portions.

There is further disclosed herein a method of producing a diffraction pattern including a diffraction grating, the pattern when illuminated producing a recognisable image on a surface intercepting the diffracted light, said method including the steps of:

providing a data stream indicative of the image;

processing the data to determine the configuration of said grating and therefore said pattern, with a characteristic of the processed data corresponding to a physical characteristic of the grating;

providing a plate having a surface to be deformed to have a configuration corresponding to said pattern;

deforming the plate surface in accordance with said data so as to produce said configuration; and wherein

a physical dimension of the grating is determined by said characteristic, and said grating includes a plurality of surface portions from which the light is diffracted to form said image, said surface portions being distributed over the plate surface so as not to be substantially concentrated.

There is further disclosed herein a method of producing a diffraction pattern including a diffraction grating, the pattern when illuminated producing a recognisable image on a surface intercepting the diffracted light, said method including the steps of:

providing a data stream indicative of the image;

processing the data to determine the configuration of said grating and therefore said pattern, with a characteristic of the processed data corresponding to a physical characteristic of the grating;

providing a plate having a surface to be deformed to have a configuration corresponding to said pattern;

deforming the plate surface in accordance with said data so as to produce said configuration; and wherein

said configuration includes first area portions and second area portions, with the width of said first area portions being less than the wavelength of light.

Preferably, the physical dimension is the width of ridges formed on said surface.

There is further disclosed herein a diffraction grating occupying a surface having a first portion spaced from a second portion, with said first portion being configured so that when illuminated a first image is produced on a receiving surface by light diffracted from said first surface, said second surface portion being configured so that when illuminated a second image is produced on said receiving surface by light diffracted from said second portion, the surfaces being configured so that said second image is an alteration of said first image so that when said first portions and second portions are illuminated by a specified light beam moving from said first portion to said second portion, the change occurs in said first image to produce said second image.

There is further disclosed herein a layer having a diffraction surface, said surface comprising:

first area portions;

second area portions surrounded by and generally separated by the first area portions so as to produce a grid; and wherein

said second area portions have a width extending generally parallel to the surface, so that corresponding portions of parallel adjacent first area portions are spaced about 0.3 to about 2.0 times the wavelength of a reading light.

There is still further disclosed herein a diffraction grating occupying a surface having a first portion spaced from a second portion, said first portion being configured so that when illuminated a first image is produced on a receiving surface by light diffracted from said first portion, said second portion being configured so that when illuminated a second image is produced on said receiving surface by light diffracted from said second portion; and wherein said surface has an intermediate portion configured so that when illuminated by a light beam moving from a first position illuminating said first portion to a second position illuminating said second portion, an intermediate image is produced on said receiving surface, by light diffracted from said intermediate portion, said intermediate image being initially a transformation of said first image which changes to a transformation of said second image as said beam approaches said second portion.

### BRIEF DESCRIPTION OF THE DRAWINGS

A preferred form of the present invention will now be described by way of example with reference to the accompanying drawings wherein:

FIG. 1 is a schematic illustration of an image and a process for producing a diffraction grating from an image;

FIG. 2 is a schematic illustration of data from which a diffraction grating may be produced;

FIG. 3 is a schematic representation of a diffraction grating;

FIG. 4 is a schematic illustration of an optical surface comprising a first region, a second region and a so-called transition region;

FIG. 5 is a schematic illustration of a close-up view of the optical surface of FIG. 4 showing the surface to be made up of cells;

FIG. 6 is a schematic illustration of the optical properties of the first and second regions of FIG. 4;

FIG. 7 is a schematic illustration of a portion of a cell of the optical surface of FIG. 4 showing the cell to be made up of so-called blocks;

FIG. 8 is a schematic illustration of a single block of FIG. 7;

FIG. 9 is a schematic illustration of an optical surface of a type which produces projected images from an incident light beam;

FIG. 10 is a schematic illustration of an example of a movement animation effect in the projected images of FIG. 9;

FIG. 11 is a schematic illustration of an example of an intensity animation effect in the projected images of FIG. 9; and

FIG. 12 is a schematic illustration of a close-up view of a preferred embodiment of a design for the optical surface illustrated in FIG. 9.

### DETAILED DESCRIPTION OF THE PREFERRED EMBODIMENT

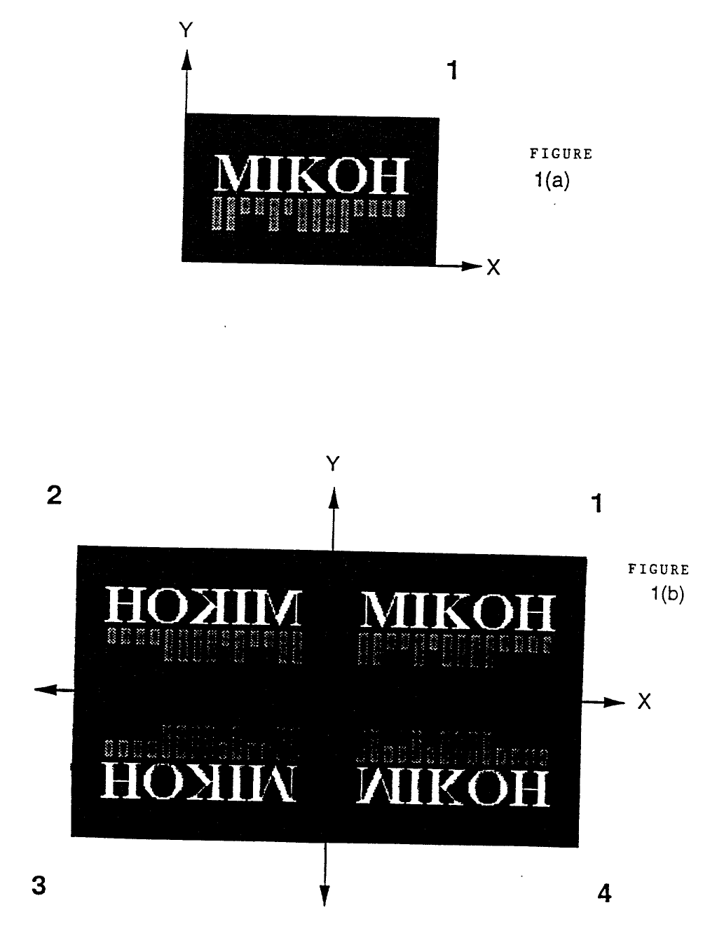

In FIG. 1(a) there is illustrated an image from which a diffraction grating will be produced so that if the grating is illuminated by a suitable light source the diffracted light will produce the image on a screen. A solid state laser is an example of a suitable light source. More particularly, the actual grating itself cannot be directly viewed for the purpose of seeing the image. The diffracted image can only be seen via appropriate illumination of the grating in which case the image will be seen on a screen receiving the diffracted light from the grating.

It should be noted that the image of FIG. 1(a) is a combination of both text and graphics and includes shaded (i.e. grey scale) regions. To manufacture the diffraction grating the image of FIG. 1(a) or a symmetrically disposed version of it as described below, is scanned so as to produce a stream of data indicative of the image. The stream of data is obtained by dividing the image into a number of pixels or elements, and determining a data value or set of data values indicative of each pixel or element. The density of pixels in the scanning process is chosen so as to produce sufficient image quality in the diffracted images. For example, the image may be scanned into a 128 by 128, or 256 by 256, or 512 by 512 array of pixels. The two dimensional fast Fourier Transform is then used to compute from the stream of data the diffraction image from which the diffraction grating is produced. In general the fast Fourier Transform consists of two parts: a so-called real part (representing the amplitude component) and a so-called imaginary part (representing the phase component).

An image which is symmetrical about two orthogonal axes, the X and Y axes, has no variation in the imaginary part of its Fourier Transform and therefore the phase component of the Fourier Transform can be ignored.

An image which is not symmetrical about the X and Y axes has a variation in the imaginary part of its Fourier Transform. In the present invention a non-symmetrical image can be modified such that the phase component of the Fourier Transform can be ignored. This modification occurs by taking the original image and forming from it a symmetrical image by producing mirror images about the X and Y axes. The resulting image consists of four components mirrored about the X and Y axes and is therefore symmetrical. FIG. 1(b) illustrates such a symmetrical image derived from the nonsymmetrical image of FIG. 1(a). Consequently this symmetrical image has no variation in the imaginary part of its Fourier Transform and therefore the phase component of the Fourier Transform can be ignored.

A difficulty with the Fourier Transform technique as used conventionally is that most of the information in the Fourier Transform is contained in a small portion of the Fourier Transform data. In the present invention this means that only a small area of the resulting diffraction pattern will be responsible for producing the image. Consequently much of the incident reading light beam will be diffracted into a conventional diffraction spot, resulting in relatively little light intensity in the diffracted images. A method of overcoming this disadvantage is to modulate the data produced by the Fourier Transform through the use of a random phase number sequence as described below. In the present invention the random phase number sequence must preferably be odd symmetric in two dimensions as described below.

A further improvement to the diffracted images can be made through clipping and quantising of the data provided by the fast Fourier Transform. The fast Fourier Transform data may be clipped to a percentage, for example 50%, of the peak calculated level. The resulting clipped data may then be quantised into a discrete number of levels within the clipping range. For example, the data produced by the fast Fourier Transform after clipping could be quantised into fifty, or ten, or even only three discrete levels within this clipping range. As an illustrative example it has been found in one particular case that an 80% clipping value and ten quantising levels produce a clear and stable diffracted image, although it should be appreciated that other combinations of clipping and quantising levels may be optimal for other images.

An example of a specific sequence of functions carried out in order to take the original image and convert it into processed Fourier Transform data from which the diffraction grating can be produced is as follows. This procedure is illustrated in simplified form in FIGS. 1(c) to 1(g), which show the steps involved in processing data to produce a diffraction grating from the simple image of FIG. 1(c). The original image of FIG. 1(c) is made up of a pattern of nine squares shaded with different grey scale levels. Normally the original image would be far more complex than the image of FIG. 1(c), and could for example be of the type illustrated in FIG. 1(a).

1. The original image is positioned in quadrant 1 of an X-Y Cartesian plane (FIG. 1(c)). It should be appreciated that the smaller the image area as a proportion of the delineated area in quadrant 1, the brighter (i.e. higher intensity) the resulting diffracted image. This can be understood in terms of the diffracted optical power from the finished optical surface being an approximately fixed proportion of the incident optical power. Hence making the diffracted images a smaller proportion of the total image plane area concentrates this approximately fixed proportion of the incident power into a smaller area, thereby increasing the diffracted image intensity.

2. The digitised image is produced. The original image as positioned in quadrant 1 is digitised into a Cartesian array of a specified size. Each element in the array is assigned a digitised, or quantised, value (from a specified range of digitising levels) according to the grey scale level of the corresponding element of the original image. In the case of the simple original image of FIG. 1(c), quadrant 1 is digitised into an 8×8 array which aligns with the squares making up the image. It should be appreciated, however, that in the more general case the original image will be far more complex than the image in FIG. 1(c) and will be digitised into a larger array—for example a 128 by 128, or 256 by 256, or 512 by 512 element array.

3. The four-quadrant symmetrical image is generated from the digitised image. This process may be carried out either physically or electronically. The digitised image in quadrant 1 is mirrored about the Y axis and the resulting pattern in quadrant 2 is shifted one pixel in the positive X direction, leaving a column of zero value pixels at the left hand border of quadrant 2. The top half plane (positive Y values) is mirrored about the X axis and the resulting bottom half plane (negative Y values) pattern is then shifted one pixel in the negative Y direction, leaving a row of zero value pixels along the top of the bottom half plane (FIG. 1(d)).

4. The odd symmetric “random phase noise contribution” is determined. Using the same digitising array layout as for the image, random phase contributions, ranging between 0 degrees and 360 degrees, are allocated to the pixels in quadrant 1, except that the pixels in the left hand column and top row in quadrant 1 all have zero value. The phase noise pattern in quadrant 1 is mirrored about the Y axis into quadrant 2 and the resulting pattern shifted 1 pixel in the positive X direction, leaving zero :values in the pixels of the left hand column and top row of quadrant 2 (FIG. 1(e)). The top half plane (positive Y values) is mirrored about the X axis and the resulting bottom half plane (negative Y values) pattern is then shifted one pixel in the negative Y direction, leaving zero pixels in the top row of the bottom half plane as well as in the left hand column of both quadrants 3 and 4. The phase signs in the bottom half plane are reversed (i.e. positive becomes negative, so that for example +180 becomes −180), so that the phase noise contributions in the bottom half plane range between 0 and −360 degrees (FIG. 1(e)). In FIG. 1(e) various grey scale shades are used to represent the phase noise value in each pixel with a zero value being represented by a medium grey shade.

It should be noted that the random number phase noise contribution may be “seeded” such that different random phase noise data are used in different grating designs, thereby increasing the overall security of the technology and reducing the correlated noise between images in animated image sequences.

5. The “real” and “imaginary” components of the complex fast Fourier Transform (FFT) input data are generated from the symmetric image data and random phase noise contribution. For each pixel in the array the following computation is performed:

Real component of FFT input=amplitude×cosine (theta)

Imaginary component of FFT input=amplitude×sine (theta) where:

amplitude=value of the symmetrical image at that pixel

theta=value of the random phase noise contribution at that pixel.

6. The fast Fourier Transform of the above FFT input data is computed. The objective is to achieve a wholly real FFT result since this is more readily produced in physical form as a diffraction grating. As a result of the symmetry properties of the symmetrical image and random phase noise contribution, the resulting FFT should be real only. The complex FFT output is generated in order to check that this is so.

7. The basic diffraction grating data are generated via a complex to real conversion of the complex FFT output data for each pixel. For each pixel the imaginary component of the complex FFT output (which should in any case be zero) is discarded and only the real part retained. FIG. 1(f) shows the basic diffraction grating data for the image of FIG. 1(c). Note that in FIG. 1(f) the value of the basic diffraction grating data is indicated as a grey scale level.

8. The basic diffraction grating data is clipped and quantised to compute the processed diffraction grating data. In other words the basic diffraction grating data is restricted to certain extreme values and any data outside these limits is set at these extreme values. The resulting clipped data is then quantised within a specified number of quantising levels. The clipped and quantised data is then normalised within two specified limits, commonly between 0 and 1, so that a normalised value of 0.5 is approximately equivalent to a zero value in the basic diffraction grating data, bearing in mind that the basic diffraction grating data can be positive or negative and will usually be distributed approximately symmetrically about zero. Whether normalised or not, the lower clipped value represents minimum modulation in the final diffraction grating. while the upper clipped value represents maximum modulation in the final diffraction grating. In the case of a block grating design (as described herein) minimum modulation implies no etching of a block, while maximum modulation implies maximum etching of a block. The quantising levels whether distributed linearly or non-linearly over the range of FFT output values, usually represent uniform or linear steps in the modulation of the final diffraction grating. It should be appreciated. however, that the quantising levels may correspond in a non-linear manner to the modulation values for the final diffraction grating. FIG. 1(g) illustrates the processed diffraction grating data (after quantising and clipping) for the original image of FIG. 1(c). In this case 50 quantising levels have been used. In FIG. 1(g) the quantised value of the processed diffraction grating data in each pixel is represented as one of 50 grey scale levels.

It is found empirically that, given a fixed number of quantising levels, it is acceptable to clip approximately the highest and lowest 2% of the peak values of the processed Fourier Transform data. This allows more values in the processed diffraction grating data array to be different and to therefore carry useful information. Noise on the diffracted images is minimised by adjusting the clipping of the basic diffraction grating data so that after quantisation the minimum number of points in the processed diffraction grating data array have the same data value. Excessive clipping will cause an increase in the number of pixels at the maximum or minimum (i.e. clipped) data values, while too little clipping will cause statistical bunching of the number of pixels at small data values with few pixels at the larger values. For example, with 50 quantising levels, optimal clipping will usually result in the number of identical data values in the processed diffraction grating data array not exceeding a few percent. Ideally the average value of the processed diffraction grating data should be approximately half way between the maximum and minimum clipped values, so that in a block grating design (as described herein) the average etched area of the blocks (the average being taken across the grating) will be approximately 50% of an enclosed area of the mesh pattern.

An alternative to clipping and quantising is to use a non-linear quantising scale to allocate the FFT output data in a non-linear or non-uniform manner to the various quantising levels. The quantising levels may represent linear (i.e. uniform) or nonlinear steps in the modulation of the final diffraction grating. It should be noted that striking visual effects can be generated in the diffracted images through the use of a non-linear relationship between the quanitising levels and modulatuion of the final diffraction grating. Use of a non-linear quantising scale to allocate the FFT data may be designed to have an effect analogous to clipping and quantising in that, given a maximum number of available quantising levels in the processed diffraction grating data, it acts to equalise the distribution of data values among these quantising levels. The non-linear quantising scale is defined in each case so as to reduce the number of identical values in the processed diffraction grating data array.

By way of illustration, in one example based on a 256×256 FFT data array, the peak numerical values of +698 and −738 were clipped to +150 and −150 respectively, thereby clipping approximately 2% of the total number of data points. With 50 quantising levels this resulted in the maximum number of identical values in the processed data array being around 4% of the total number of points in the array. This clipping and quantising produced clear and stable images. On the other hand in the same example it was found that clipping the peak values to +100 and −100 produced a noticeable increase in the noise on the diffracted image. Typically 50 quantising levels or thereabouts is found to produce good quality diffracted images, although it should be appreciated that a different number of quantising levels could be used instead.

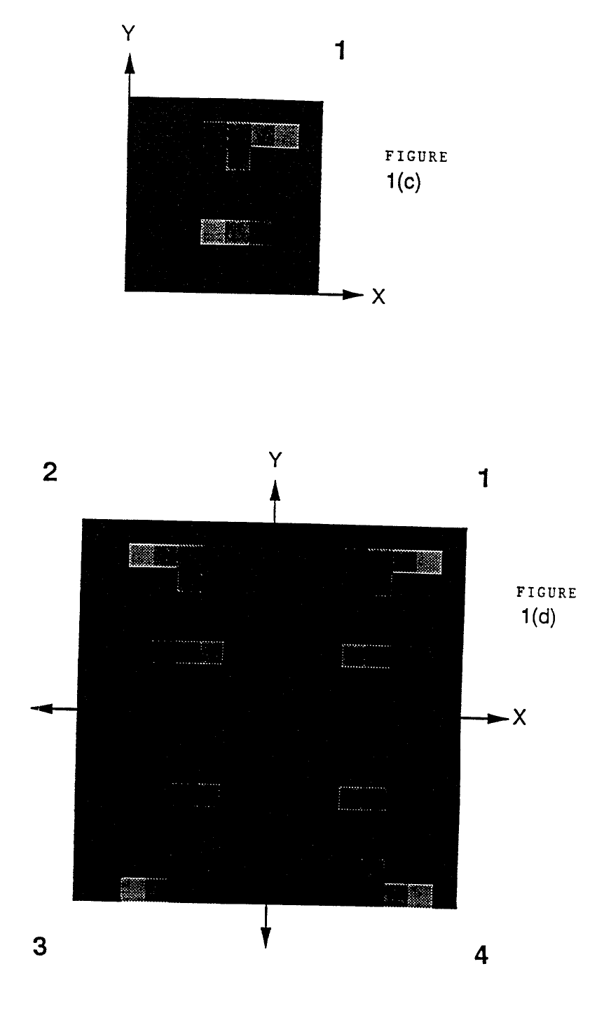

FIG. 2(a) depicts schematically one quadrant of a typical diffraction grating data array derived without the use of an above described random number phase sequence, while FIG. 2(b) depicts schematically the corresponding quadrant of the diffraction grating data array derived with the use of a random number phase sequence. (FIGS. 2(a) and 2(b) are 64 by 64 data arrays derived from an original image more complex than that of FIG. 1(c).) By comparing FIGS. 2(a) and 2(b) it is apparent that the use of the random number phase sequence has overcome the above described disadvantage with regard to concentration of the diffraction image information in the resulting diffraction grating pattern, since in FIG. 2(b) the diffraction image information is not concentrated in any one portion of the grating pattern but is rather distributed across the entire grating pattern, whereas in FIG. 2(a) the diffraction image information is concentrated into a limited region of the grating pattern.

The processed diffraction grating data (derived as described above) is used to control a device capable of producing the physical diffraction grating. A preferred device for this purpose is an electron beam lithography machine. This machine etches a suitably prepared glass plate or other material according to the processed diffraction grating data. In other words the processed diffraction grating data is etched into the plate by modulating the areas, or widths, or some other property, of the pattern recorded on the plate, said modulation at a particular point being dependent on the processed diffraction grating data value at that point. In this case the processed diffraction grating data may be rearranged or reformatted in a form suitable for interpretation by the electron beam lithography machine. Other parameter values—for example, representing the physical size of the mesh in the mesh pattern of a block grating, or the number and layout of block gratings forming the overall diffractive surface—may also be input, along with the processed diffraction grating data, in order to enable production of the etched plate. It should be appreciated that the grating pattern formed in this way if illuminated by a suitable reading light beam will provide on a screen or optical sensor the symmetrically disposed version of the original image for example the symmetrical image of FIG. 1(b), derived from the original image of FIG. 1(a). The illumination would for example be by way of a laser diode with the output beam of said laser diode suitably configured using a lens arrangement. It should be appreciated that the electron beam lithography machine may be used to record either the positive or the negative (i.e. the inverse) of the processed diffraction grating data.

As discussed herein, if the original image is symmetrical about the X and Y axes or is modified so as to be symmetrical about the X and Y axes, then only the amplitude information in the resulting Fourier Transform need be recorded in the grating pattern. The image resulting from illumination of the etched plate will then consist of the symmetrically disposed image. For example, if the image of FIG. 1(b) is used to derive the diffraction grating data, then the image resulting from illumination of the etched plate will be the image of FIG. 1(b), with specular reflection of the illuminating beam occurring at a position equivalent to the origin of the X, Y plane in the original symmetrical image.

In general it is therefore possible to configure any image in such a way that only the amplitude information of the processed Fourier Transform data need be recorded on the etched plate.

The Fourier Transform of the data stream, after the above processing, (the processed diffraction grating data), can be recorded either directly on the plate or can be recorded as modulation of an underlying diffraction grating. This underlying diffraction grating could be one of a number of grating types and for example could be a simple straight line grating.

If the processed diffraction grating data is recorded directly on the plate then the amplitude of the processed data may be represented at each of a number of discrete points on the plate by the properties of an etched region at that point. In this way the resulting etched plate when viewed microscopically would consist of an array of columns or pits, where the properties of each column or pit represent the amplitude of the processed diffraction grating data at that point on the etched plate. The properties of the etched region used to represent the processed diffraction grating data may include area (parallel to the plane of the plate surface), shape (as viewed from above the surface of the plate), position, height or depth, and height or depth profile of each column or pit. In a simple implementation the area of each column or pit may represent the amplitude of the processed diffraction grating data at that point on the etched plate. In this case the columns or pits may have any cross sectional shape (i.e. the shape when viewed from above the plate), but for example will commonly be square or rectangular in shape. If the processed diffraction grating data is recorded directly on the plate in the manner described above then the diffraction image formed on appropriate illumination of the etched plate will occur around the specular reflection direction for the illuminating beam as well as around the higher diffraction orders. A preferred embodiment of a grating produced by recording the processed diffraction grating data directly onto the etched plate is a so-called block grating. A block grating is produced by generating a mesh pattern on the plate where the mesh pattern is made up of enclosed areas such as squares, rectangles, triangles or some other shape. For example, in one preferred embodiment a block grating may include a mesh pattern of enclosed squares. Each enclosed area will include an etched region where the properties of the etched region represent the amplitude of the processed diffraction grating data at that point. The properties of the etched region used to represent the processed diffraction grating data may include the area (parallel to the plane of the plate surface), shape (as viewed from above the plate surface), position, depth, and depth profile. In a simple implementation each enclosed area in the mesh pattern may include an etched region where the area of the etched region represents the amplitude of the processed diffraction grating data at that point. In the case of such a block grating the diffracted image formed on appropriate illumination of the etched plate will occur around the specular reflection direction for the illuminating beam as well as around the higher diffraction orders resulting from the mesh pattern incorporated into the plate.

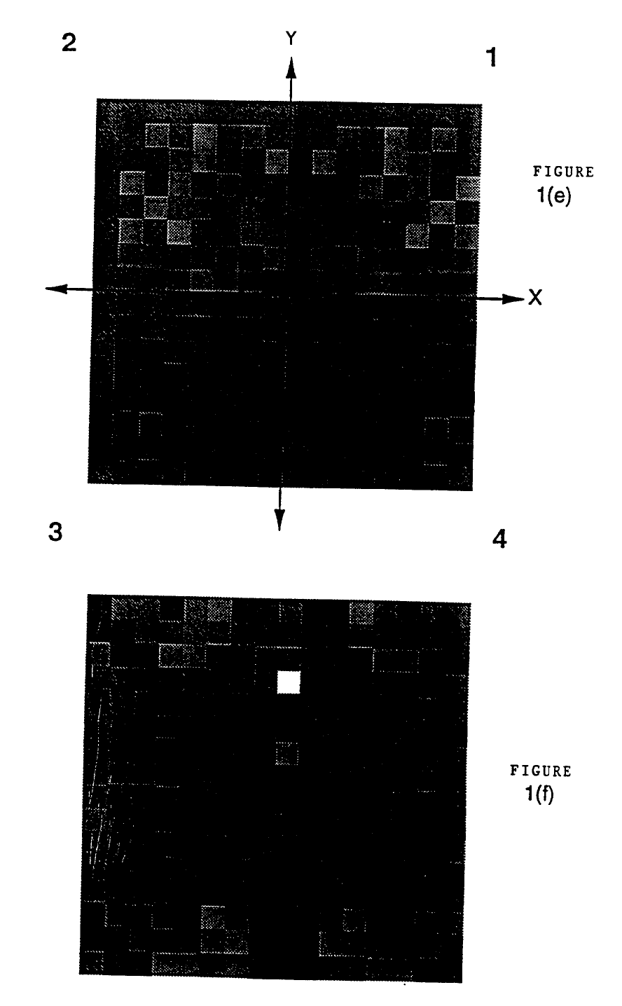

In FIG. 3 there is schematically shown a block grating 10. The grating 10 includes a series of first ridges 11 extending in the direction of the arrow 12 and a series of second ridges 13 extending in the direction of the arrow 14. Ridges 11 and 13 are generally arranged at right angles and provide a mesh pattern of enclosed squares or rectangles. The enclosed squares or rectangles include recesses 15 with the ridges 11 and 13 being displaced above the level or levels of the recesses 15. The ridges 11 and 13 in cross section are convex and either or both may have a transverse width less than the wavelength of the reading light beam. Light striking the ridges 11 and 13 is not reflected in a conventional manner since the transverse widths of the ridges 11 and 13 may be less than the wavelength of the incident light. In this design method, modulation of the block grating according to the processed diffraction grating data is achieved through modulation of the etched area within each block i.e. within each enclosed area of the mesh pattern. Hence in FIG. 3 each of the recesses 15 has been etched with an area which represents the processed diffraction grating data value at that point. For example, if the processed diffraction grating data has been normalised between 0 and 1, then a value of 0.4 indicates that the etched area in the corresponding block should be 40% of the total block area. In this block grating design type it is found empirically that adjustment of the depth of the etching process can be used to optimise the combination of brightness and resolution of the resulting diffracted images. Increasing the etching depth is found to produce brighter diffracted images although etching too deeply causes over etching at the top surface of the grating (since the walls of the etched regions are not perfectly perpendicular) which results in a loss of resolution in the resulting diffracted images. Hence there is an optimum etching depth which is determined by the properties of the etching process.

By way of illustration, the spacings between adjacent ridges in a block grating of the type illustrated in FIG. 3 which is intended for use with red laser light will typically be in the range 0.5 microns to 1 micron, while the ridges 11 and 13 will typically have widths in at least some portions of the block grating which are much less than the wavelength of the light used to view the diffracted images produced by the grating. The properties used to represent the processed diffraction grating data within each enclosed area in the mesh pattern of a block grating will typically be determined and etched to an accuracy of much less than the characteristic dimension of the block grating—for example with currently available technology the positioning accuracy of the features on the grating is 5 to 10 nanometres—i.e. around 0.5% to 1 % of the side length of an enclosed square or rectangle. However, these figures are illustrative only and should not be regarded as limiting.

An alternative technique for recording the processed diffraction grating data is as modulation on an underlying grating. The underlying grating may for example be a conventional straight line diffraction grating or may instead be a grating consisting of curved lines. In this case the amplitude information in the processed Fourier Transform can be recorded as the widths of the underlying grating lines at each point on the etched plate. The images formed on illumination of the etched plate will occur about the specular reflection direction for the illuminating beam as well as around each of the diffraction orders which would normally occur for the umnodulated grating.

It should be appreciated that the present invention does not rely on differences in optical reflectivity or optical transmissivity between the etched and unetched regions of the optical surface, and that in the preferred embodiments of the optical surfaces described herein the surfaces will be uniformly optically reflective or transmissive. For example in the preferred embodiment of the surface of FIG. 3 the entire optical surface, including both the ridges 11 and 13 and the recesses 15, will be uniformly optically reflective or transmissive. Thus the present invention differs from a number of the existing methods, such as so-called binary phase holograms, which rely on differences in reflectivity or transmissivity between treated and untreated regions of the diffractive surface.

The etched plate produced using the electron beam lithography machine can be used subsequently to produce a commercially viable optically diffractive surface. This surface may for example be in the form of a thin foil. The process of producing optical foils from the etched plate involves electroplating of the etched plate to produce a master shim from which embossing shims are copied. The embossing shims are used to mechanically copy the surface pattern taken from the etched plate into a layer of the foil which is then coated to provide mechanical protection for the fine embossed structure. The essential point is that the embossed layer within the foil is uniformly optically reflective or transmissive, since the embossed surface either begins with the desired optical reflection or transmission characteristic or is, after embossing, coated with a layer of uniform optical reflectivity or transmissivity. Suitable illumination of the foil results in production of the diffracted image as from the etched plate. Hence the optical surfaces in the present invention do not rely on differences in optical reflectivity or transmissivity between the etched and unetched regions of the surface. For example in the case of the preferred embodiment of FIG. 3 produced in a silver reflective foil form, the entire optical diffraction surface, including both the ridges 11 and 13 and the recesses 15, are uniformly optically reflective.

An advantage of using a block grating design, as illustrated in FIG. 3, as opposed to a modulated line grating, as described above, is that the block grating enables more quantising levels to be incorporated into the processing of the Fourier Transform data and production of the etched plate. This is because in the case of the block grating the reflective areas have two variable dimensions rather than only one in the case of the line gratings. If the electron beam lithography machine is capable of n quantising levels in the case of a line grating the same electron beam lithography machine is capable of n² quantising levels in the case of the equivalent block grating. An increase in the number of quantising levels leads to an overall improvement in the quality of the diffracted image. Hence, for example, in the case of a block grating it may be possible to use fifty quantising levels where less than ten would be possible in the case of the equivalent line grating. Indeed a typical configuration for a block grating may involve the use of fifty quantising levels to produce clear stable diffracted images.

In the above discussed embodiment, the image is described as being projected onto a screen. In this regard it should be appreciated that light sensors could be employed to recognise the image. That is, the image could be specifically tailored (designed) to be particularly suitable for machine readability (machine recognisable). This would be particularly advantageous for high security identification and authentication applications such as credit cards, personal identification cards and product security.

The above discussed grating could be applied to any article for the purposes of determining the authenticity of the article. A grating applied to the article would be simply illuminated and the image projected on the screen and viewed to determine the authenticity of the article. Alternatively the image may be projected onto an optical sensor and machine recognised in-order to determine the authenticity of the article. Only authentic articles would be provided with the grating, as unauthorised reproduction of the grating would be impossible without access to the above discussed method of producing the grating.

In many instances it is beneficial to scale the size of the diffraction image and the spacing of the diffraction image according to the requirements of the application. This can be done in a straightforward manner by scaling the grating pattern produced as described above. In general reducing the size of the grating pattern will produce larger and more widely spaced images while increasing the size of the grating pattern will produce smaller more closely spaced images. The relationship between the variations in grating size and the size and spacings of the images are well known according to conventional diffraction theory. A particular advantage of reducing the grating size is that the first order diffraction patterns can be removed completely. This has the advantage of concentrating all of the diffracted light into the so-called “zero order” diffracted images around the specular reflection direction for the illuminating beam, thereby making these images substantially brighter. This also has the further advantage of making the image grating detail considerably more difficult to view via the use of an optical microscope and therefore also considerably more difficult to copy or counterfeit.

Using the techniques described herein it is possible to use a very small grating pattern to produce totally acceptable and recognisable diffracted images. Typically the grating patterns would occupy a square area having a side length of 0.1 mm to 0.5 mm in size, although larger or smaller grating patterns may also be used. Also other configurations may be employed such as triangular, circular or rectangular. A diffracted surface as used to authenticate a product may be made up of a series of basic grating patterns repeated across the surface. Each of these grating patterns may be as small as 0.1 mm by 0.1 mm. If illuminated by a suitably configured and essentially monochromatic beam of light the projected diffracted image produced by such a grating pattern is clear and stable. Such a diffractive surface may be used as described herein to authenticate an object.

The optical surfaces described herein are designed to produce specified diffracted images when suitably illuminated, said images being produced around the various diffraction orders. In particular the diffracted images produced around the specular reflection direction—the zero order diffraction images—are of interest. In the preferred embodiment illustrated in FIG. 3 the optical surface is made up of a regular array of square or rectangular “cells” defined by the ridges 11 and 13, with each cell includin2 an approximately square or rectangular recess 15, where in each cell the widths of the ridges 11 and 13 and the configuration of the recess 15 are determined as described herein.

The spacings of the ridges 11 and 13, and hence the dimensions of the “cells”in the surface design of FIG. 3 can be specified independently of the angular sizes and angular positions of the zero order diffraction images produced by the surface of FIG. 3. In other words, a number of different surface designs of the type illustrated in FIG. 3 could be developed to produce essentially the same zero order diffraction images, with the various surface designs differing in the spacings of the ridges 11 and 13 (and also in the configurations of the recesses 15).

The angular positions of the higher diffraction orders produced by the surface design of FIG. 3 depend on the spacings of the ridges 11 and 139 with smaller spacings producing larger diffraction angles for the higher diffraction orders.

Hence optical surfaces of the type described herein can be designed such that the angular sizes and angular positions of the zero order diffraction images are specified independently of the angular positions of the higher diffraction orders produced by such surfaces.

The present optical surfaces therefore provide a degree of freedom not available from imitative optical surfaces recorded using conventional holographic techniques. In the case of a holographically recorded surface the angular positions of the various diffraction orders are specified by the configuration of the recording set-up, and it is not possible to specify the angular positions of a set of holographic projection images independently of the angular positions of the higher order images. In the case of the optical surfaces described herein the ability to specify the angular sizes and angular positions of the zero order diffraction images independently of the angular positions of the higher diffraction orders therefore provides a means to distinguish the optical surfaces described herein from imitative holographic surfaces.

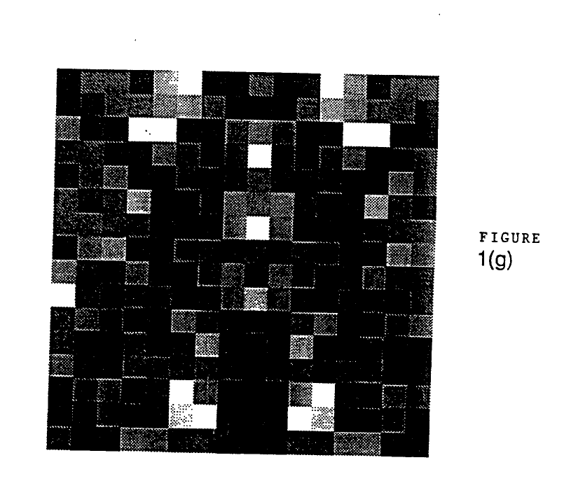

Using the techniques described herein for designing and producing diffractive optical surfaces, and in particular the so-called block grating technique as illustrated in FIG. 3, it is possible to generate diffracted images which evolve in a specified manner from one image to another as a specified incident beam of light is moved across an optical surface. FIG. 4 is a schematic illustration of an optical surface 100. The surface 100 comprises three regions: the first region 101, the second region 102 and the so-called transition region 103.

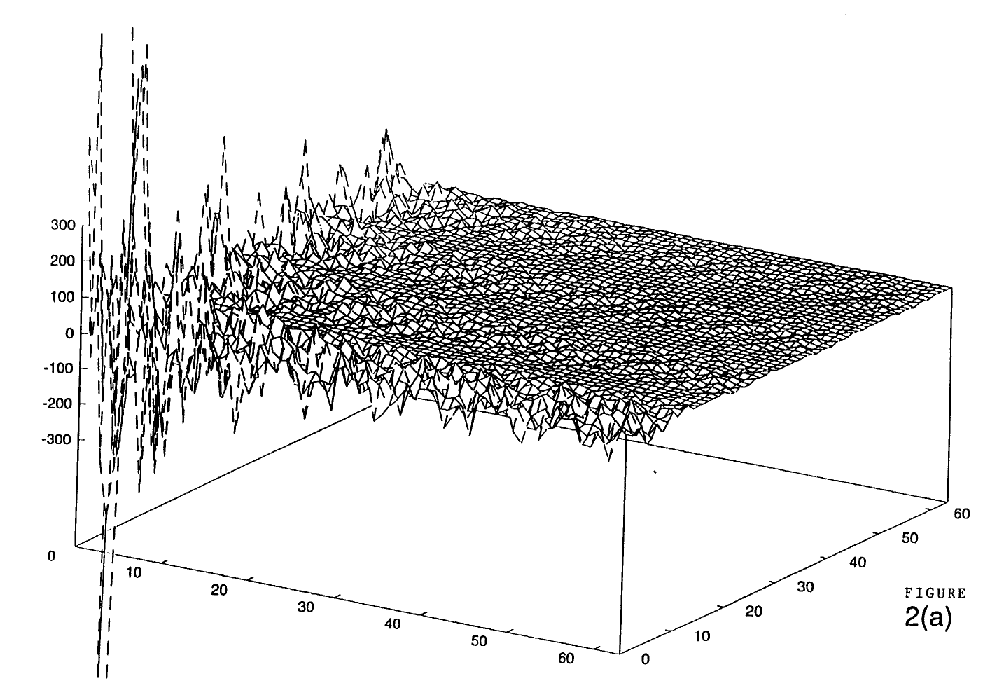

In this preferred embodiment the optical surface 100, including the regions 101, 102 and 103, is made up of basic units or cells. FIG. 5 is a schematic illustration of an area of the surface 100, showing that the surface 100 is made up of the cells 200. In the present embodiment the cells 200 in the optical surface 100 are all square and all the same size, although it should be appreciated that other configurations are possible. Each cell 200 includes an optically diffractive surface design which may preferably be a so-called block grating design as discussed herein. It should be appreciated, however, that optical surface designs other than a block grating design may be employed in the present invention. Typically, but not necessarily, the cells 200 will have a side length in the range 0.1 to 0.5 mm.

Typically the blocks would have a side length (width) of 0.3 to about 2.0 times the wavelength of the reading light beam. Preferably the width would be 0.5 to 1.5 times the wavelength.

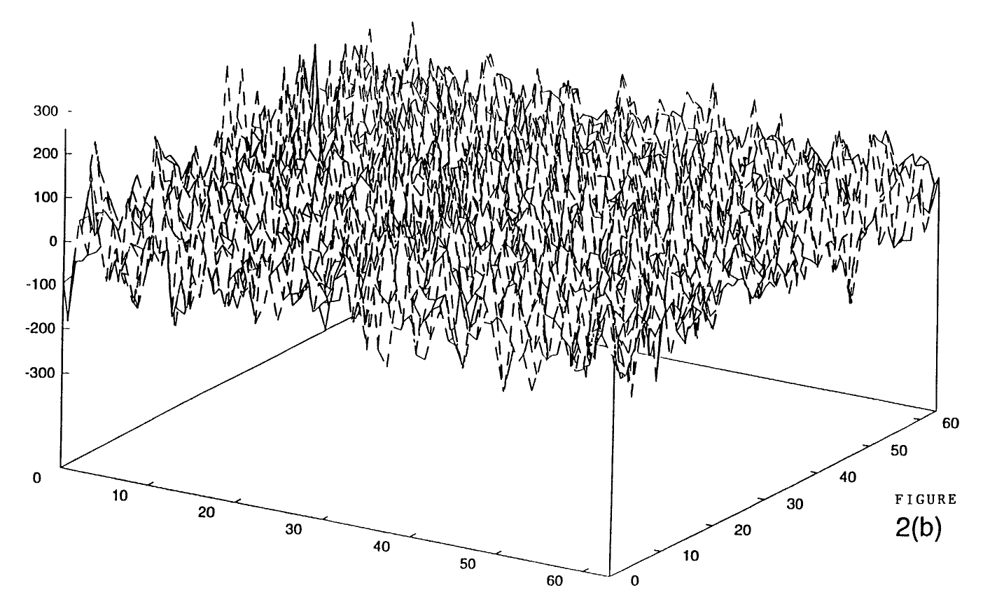

FIG. 6 illustrates schematically the optical properties of the first and second regions 101 and 102 of the optical surface 100. The first region 101 is designed to produce a first projected image 300 when illuminated by an appropriate beam of light 301, while the second region 102 is designed to produce a second projected image 302 when similarly illuminated. The projected images 300 and 302 may be projected onto a viewing screen for visual verification or onto an optical sensor for machine verification. In FIG. 6 the images 300 and 302 are shown projected onto a viewing screen 303. The images 300 and 302 may be any images and will depend on the designs of the optical surfaces 101 and 102 respectively. The light beam 301 will preferably be a specified beam of laser light. At the optical surface the beam will preferably produce a spot of light having a dimension in the direction of transformation of the optical surface—in the direction of the arrow 304 in FIG. 6—comparable with the side length of the cells 200.

As the beam of light 301 is moved continuously from the first region 101 across the transition region 103 to the second region 102, the first projected image 300 will transform into the second projected image 302. Preferably, but not necessarily, the transformation of the image 300 into the image 302 will be smooth and continuous.

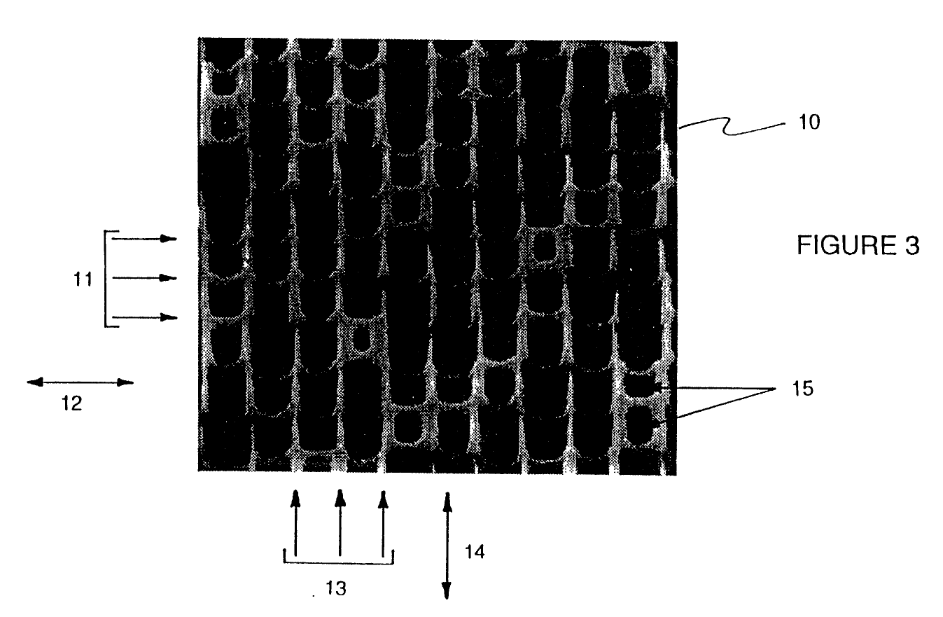

FIG. 7 illustrates schematically a close-up view of the optical surface 100, showing a portion of a cell 200. In the present preferred embodiment each cell 200 includes a so-called block grating design (as described herein), wherein the surface of each of the cells 200 is divided into a mesh pattern of enclosed areas or “blocks”, which blocks may preferably be square or rectangular in shape, or may be some other shape. Each block includes an etched region, resulting in a pit or column, where the properties (such as area, position and/or depth) of the etched region within the block are specified according to a prescribed method in order to produce the desired optical effect from the optical surface of the cell, which optical effect in the present invention is the projected image as shown in FIG. 6. For example the specification of the etched region in each block may be determined using the method described herein. The dimensions of the features within each block may be less than the wavelength of the incident light beam 301. For example in the case where each block includes an etched pit, the widths of the ridges surrounding the pit may commonly be less than the wavelength of the light beam 301.

In the preferred embodiment illustrated in FIG. 7, the block grating within each cell 200 is made up of a mesh pattern of square enclosed areas or “blocks” 350 with each block 350 having specified properties. In FIG. 7 the borders of the blocks 350 are indicated by dashed lines which are included for illustrative purposes only—in the design shown in FIG. 7 there is no physical border to each block 350. Each block 350 within a cell 200 can be specified by its position within the cell, so that for example the (m,n) block within a particular cell is the mth block from the left and nth block from the bottom within that cell. To use more precise terminology, each block within a cell can be specified in a Cartesian coordinate system by its (integer) x and y coordinates m and n respectively within that cell, using the lower left hand corner of the cell as the origin of the coordinate system. Hence the (m,n) block within one cell has corresponding (m,n) blocks within all other cells. It should be appreciated that other cell shapes and other block shapes could be used instead of the square cell and block shapes considered here.

In the present embodiment all cells within the first region 101 of the optical surface 100 are identical, and all cells within the second region 102 are identical but different from the cells in the first region 101. The cells in region 101 are designed to produce the image 300, while the cells in region 102 are designed to produce the image 302, as illustrated in FIG. 6.

The cells in the transition region 103 are designed to undergo a prescribed transformation from the design of the cells in region 101 to the design of the cells in region 102. Hence as the beam of light 301 is traversed from the first region 101 across the transition region 103 to the second region 102, the image produced from the beam of light 301 will transform from the image 300 to the image 302. The image transformation will preferably be smooth, and may be direct (i.e. the image 300 transforms directly into the image 302) or may involve passing through a number of intermediate images unlike either the image 300 or the image 302.

In the present embodiment the transformation from the cells in region 101 to the cells in region 102 can best be described with the aid of FIGS. 5 and 7. As illustrated in FIG. 5, in the present embodiment the cells 200 are square and are arranged in a square layout, although it should be appreciated that other configurations are possible. Each of the cells can be identified by a set of coordinates (X,Y) where the (X,Y) cell indicates the X^{th} cell from the left and the Y^{th} cell from the bottom as illustrated in FIG. 5—X and Y are therefore the (integer) Cartesian coordinates of the cell.

In the transition region 103 all cells with the same X value—i.e. all cells in the same column—are identical. However, in the transition region 103 cells with different X values—i.e. cells in different columns—are different in such a way that the design of a cell evolves across the transition region from the design of region 101 to the design of region 102.

This can be expressed more precisely as follows.

Consider a particular block (m,n). The properties of the (m,n) block will be denoted P(m,n). These properties may for example include the set of coordinates defining the “pit” or “column” within the block (m,n)—i.e. the region within the block (m,n) which has been etched in the process of recording the optical surface 100.

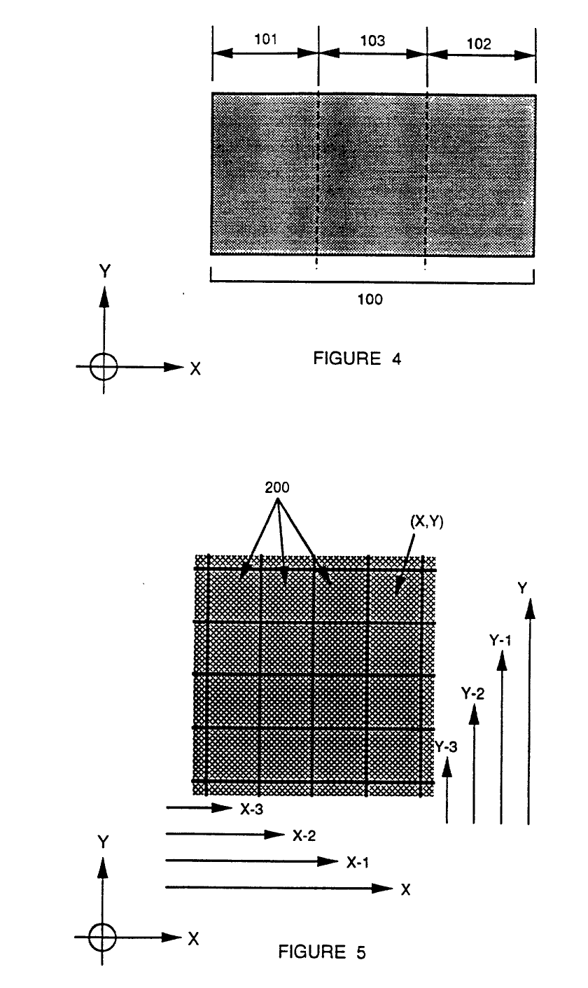

For instance, FIG. 8 is a schematic illustration of a typical block 360 which may be one of the blocks 350 in FIG. 7. In FIG. 8 it is assumed that the block 360 includes an etched region, or “pit”, 361, and that both the block 360 and the etched region 361 within the block 360 are square or rectangular. The block 360 may therefore be specified by the coordinates [x1,x2,y1,y2,D] which define the region of etching within the block 360, as illustrated, along with the depth of the etched region as represented by the parameter D. In such a configuration the properties P(m,n) of the (m,n) block may consist simply of the coordinates [x1,x2,y1,y2,D] for the (m,n) block.

It should be appreciated, however, that in some cases additional information, such as the depth profile of the etched region, may also need to be included in specifying the properties P(m,n) of the (m,n) block.

As the X value of the cells increases in traversing the transition region 103, the properties P(m,n) of the (m,n) blocks within the cells undergo a transformation from the properties P1(m,n) in the region 101 to the properties P2(m,n) in the region 102 according to a specified function F. This can be expressed mathematically as:

F{P1(m,n)→P2(m,n)}

In other words, the function F defines the transformation of the properties of the (m,n) block across the transition region 103 from the properties P1(m,n) in the first region 101 to the properties P2(m,n) in the second region 102.

In the present embodiments all cells with the same X value are identical and so the function F is not a function of Y. In other embodiments, however, this may not be the case.

In the simplest embodiment, the function F will be a function of the X coordinate of the cell only, so that all blocks within a cell will undergo the same functional transformation from the properties of the first region 101 to the properties of the second region 102.

To take a specific example, the function F may be a linear function of X only, meaning that the coordinates [x1,x2,y1,y2,D] for the (m,n) block undergo a linear transformation as X increases across the transition region 103, starting at the coordinate values for the region 101 and finishing at the coordinate values for the region 102. On the other hand, the function F may be non-linear. For example, the function F may be such that most of the variation in the coordinates [x1,x2,y1,y2,D] for the (m,n) block occurs in the middle of the transition region 103, or alternatively at either end of the transition region 103 with little variation in the middle.

In another embodiment, the function F may depend on X and also on m and n, so that different blocks (m,n) within a cell will undergo different functional transformations from the properties of the region 101 to the properties of the region 102. For example, the blocks in the top right hand corner of the cells may undergo a more strongly non-linear transformation across the transition region 103 than the blocks in the bottom left hand corner of the cells. A dependence of the function F on the block identifiers m and n as well as on the cell column number X may be beneficial in generating a particular optical effect in transforming from the image 300 to the image 302.

The function F may either be a continuous function or may be an integer function (i.e. for integer values of the variables). However, the variables X, m and n can only take on discrete values which in the present description are integer values (0, 1, 2, 3, . . .). Hence the function F will be “sampled” only at discrete values of X, m and n.

Whether the function F depends on X only or also on m and n, it should preferably be chosen so as to produce a smooth looking transformation from the image 300 to the image 302 as the beam 301 is traversed from the region 101 across the transition region 103 to the region 102. It may be necessary to use a non-linear function F to produce a smooth and continuous looking transformation from the image 300 to the image 302. In order to generate smooth image divergence and convergence during the image transformation process, it may also be important that the function F is not strongly varying and does not include strong discontinuities.

It should be appreciated that variations are possible on the preferred embodiments of FIGS. 4 to 8.

For example, it may be important to provide a projected image which consists of both a fixed image component and a “transforming” image component as described above. In this case the optical surface 100 could be made up of basic units or cells as described above, but with each cell comprising two separate sub-cells: a first sub-cell being the same in all cells and so producing a fixed or constant projected image from anywhere on the optical surface; and a second sub-cell being designed according to the principles described herein and therefore producing an image which transforms from one specified image to another as a specified beam of light is traversed across the optical surface.

The image transformation process described herein can readily be repeated across a surface to enable multiple successive projected image transformations as a beam of light is traversed across the optical surface—i.e. image 1 transforms to image 2, which transforms to image 3, and so on.

Similarly, it should be appreciated that the image 300 and the image 302 above may actually consist of a number of images, and so the image transformation process described above may involve multiple first projected images transforming into the same or a different number of second projected images as a beam of light traverses the optical surface. (The simultaneous production of a number of images from the optical surface 100 can be achieved through appropriate design of the cells 200 as described herein). For example, the first region 101 in FIG. 7 may produce several projected images which may transform and merge into a single projected image produced by the second region 102.

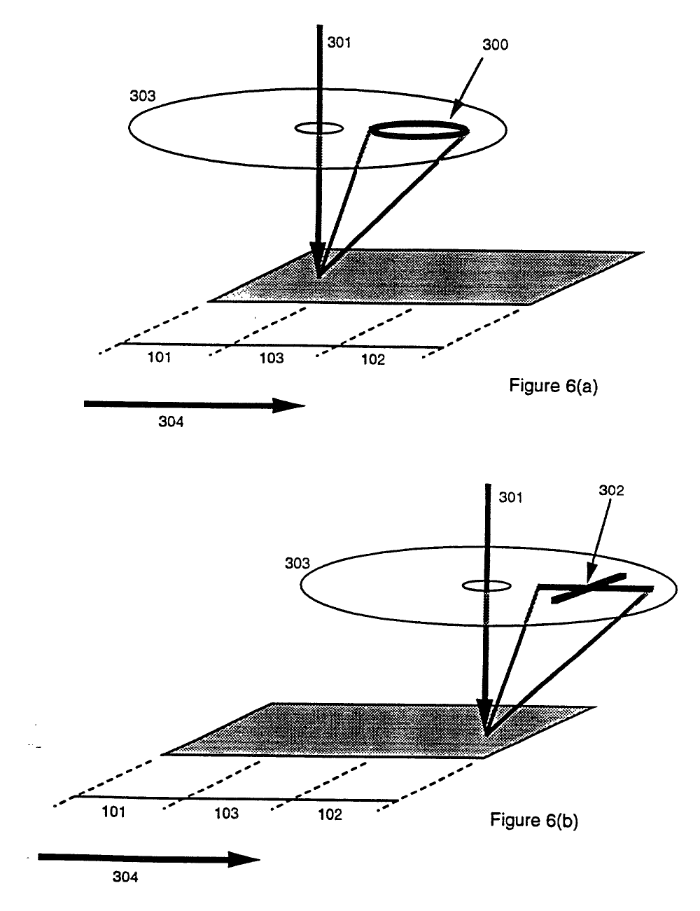

Using the techniques described herein for designing and producing diffractive optical surfaces, it is possible to generate diffracted images which display movement and/or intensity animation effects as a specified incident beam of light is moved across an optical surface. FIG. 9 is a schematic illustration of an optical surface 400 designed such that a specified beam of light 401 incident on the surface 400 in a specified manner results in the production of one or more diffracted beams 402, said diffracted beams 402 producing images 403 when intercepted by the surfaces 404. The surfaces 404 may be screens designed to present said images 403 for visual inspection or may be optical sensors designed to enable machine recognition of said images 403.

The surface 400 is designed with varying surface properties which cause animation effects in one or more of the images 403 as the incident light beam 401 is moved across the surface 400. The animation effects may for example be movement effects in the images 403 or intensity animation effects in the images 403. Furthermore the animation effects may be continuous or discontinuous.

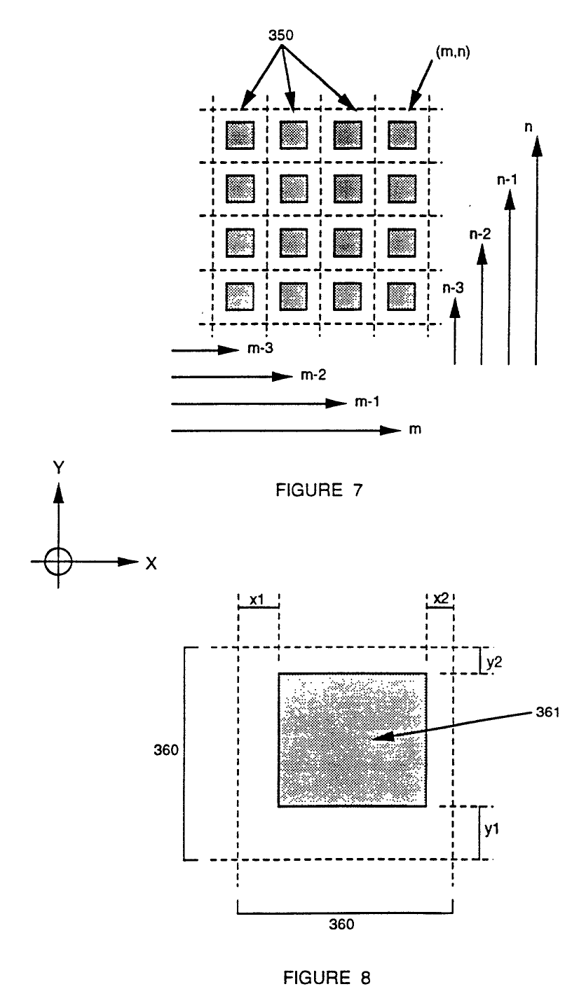

FIG. 10 illustrates an example 500 of the image 403 of FIG. 9, and a movement animation effect which may be applied to said image 500 through appropriate design of the surface 400. In this case the image 500 is an ellipse. The surface 400 may be designed such that as the light beam 401 is moved across the surface 400 the ellipse 500 rotates in either a continuous or a discontinuous manner, as illustrated schematically in FIGS. 10(a) to 10(d). The animation illustrated in the images in FIGS. 10(a) to 10(d) may repeat as the light beam 401 is moved across the surface 400. It should be appreciated that the ellipse 500 illustrated in FIG. 10 is only one example of an image which may be produced by the surface 400.

The optical surface 400 could be designed to produce any image or images 403. For example, the images 403 may be product names or logos which rotate or translate as the light beam 401 is moved across the surface 400. In another embodiment the images 403 could be images of people, animals or objects which images move or change shape as the light beam 401 is moved across the surface 400.

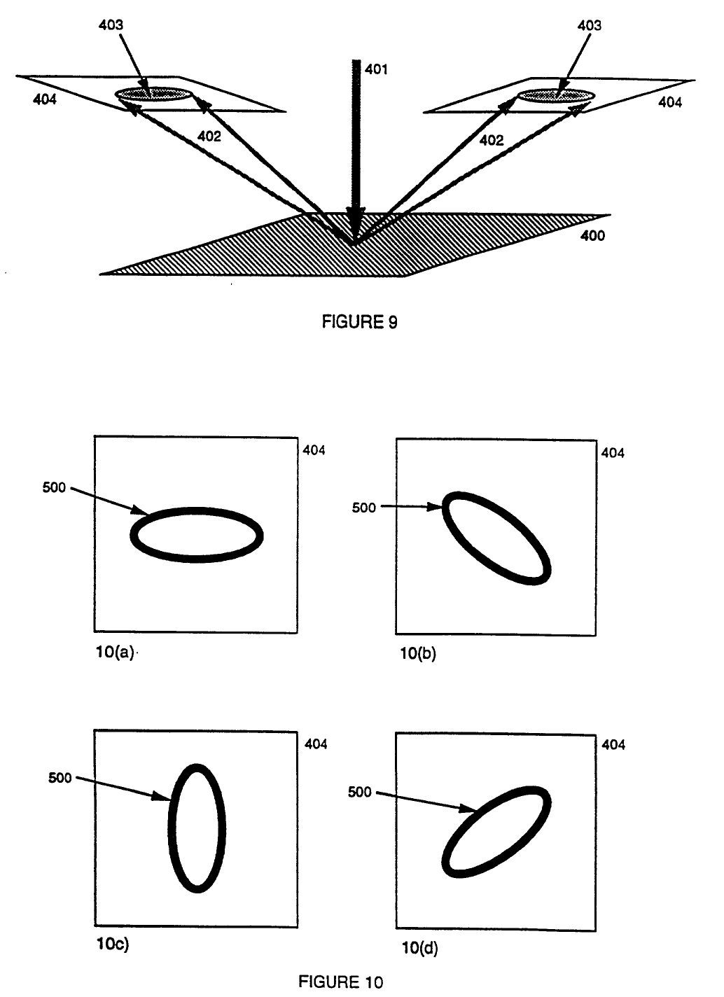

FIG. 11 illustrates another example 600 of the image 403 of FIG. 9, and an intensity animation effect which may be applied to said image 600. In FIG. 11 the image 600 is the word “TEST”, although the image 600 could instead be a brand or product name. The surface 400 may be designed in such a manner that the image 600 is made up of bright letters (shown in solid shading in FIG. 11) and dim letters (shown in outline in FIG. 11), with the combination of bright and dim letters changing as the light beam 401 is moved across the surface 400. For example, FIGS. 11(a) to 11(d) illustrate a possible animation effect as the light beam 401 is moved across the surface 400, with a bright region appearing to move through the word TEST in the sequence T, E, S, T as illustrated. The intensity animation illustrated in the images in FIGS. 11(a) to 11(d) may repeat as the light beam 401 is moved across the surface 400.

It should be appreciated that more complex intensity animation effects may be employed. For example, the surface 400 may be designed such that as the beam of light 401 is moved across the surface 400, one or more “waves” of light may move through the image 403 along a linear, circular or curved path, where the diffracted image 403 could be any image.

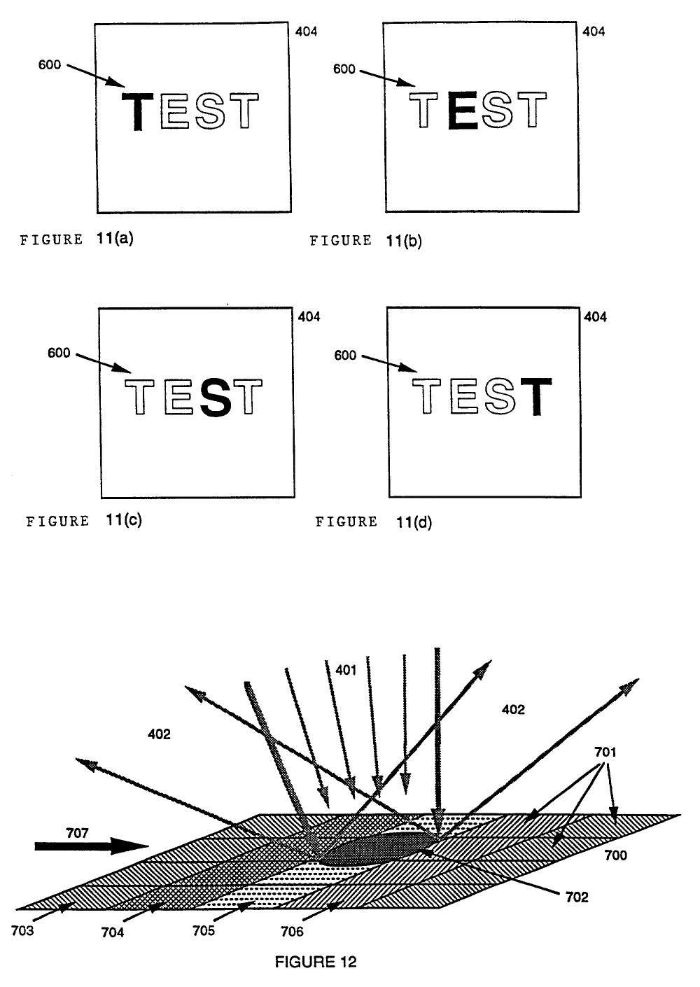

In one preferred embodiment the surface 400 may be made up of diffractive elements or pixels laid out in a regular manner. FIG. 12 illustrates in close-up view a preferred embodiment 700 of the surface 400 illustrated in FIG. 9. In FIG. 12 the surface 700 is made up of pixels 701 laid out in a square grid as illustrated. It should be appreciated that other pixel shapes and layouts could be used instead. In the embodiment illustrated in FIG. 12 the light beam 401 is configured such that the spot of light 702 at the surface 400 has approximately the same dimensions as a pixel 701. Each pixel 701 is designed to produce diffracted beams 402 and diffracted images 403.

The surface 700 is designed to produce movement and/or intensity animation effects in the images 403 (as described in relation to FIGS. 10 and 11) as the light beam 401 is moved across the surface 700. In the embodiment illustrated in FIG. 12 each of the pixels generates one “frame” in the animation sequence of the images 403. For example, the surface 700 may consist of four different pixel types—703, 704, 705, and 706, with each of the pixel types arranged in columns as illustrated. It should be appreciated that other layouts of the basic pixel types 703, 704, 705 and 706 are possible and may be used in other embodiments to produce additional optical effects. In one embodiment the surface 700 may be designed to produce the images 500 and animation effects illustrated in FIG. 10, with the pixels 703 producing the image illustrated in FIG. 10(a), the pixels 704 producing the image illustrated in FIG. 10(b), the pixels 705 producing the image illustrated in FIG. 10(c), and the pixels 706 producing the image illustrated in FIG. 10(d). Hence moving the light beam 401 across the surface in the direction of the arrow 707 will produce the images 500 and animation effects illustrated in FIG. 10. The sequence 703, 704, 705, 706 may be repeated across the surface 700.

In another embodiment the surface 700 may be designed to produce the images 600 and animation effects illustrated in FIG. 11, with the pixels 703 producing the image illustrated in FIG. 11(a), the pixels 704 producing the image illustrated in FIG. 11(b), the pixels 705 producing the image illustrated in FIG. 11(c), and the pixels 706 producing the image illustrated in FIG. 11(d). Hence moving the light beam 401 across the surface 700 in the direction of the arrow 707 will produce the images 600 and animation effects illustrated in FIG. 11. The sequence 703, 704, 705, 706 may be repeated across the surface 700.

In the preferred embodiment illustrated in FIG. 12 where the pixel types 703, 704, 705 and 706 are arranged in columns, the spot of light 702, whether circular or elliptical, will preferably have a dimension perpendicular to the columns (i.e. in the direction of the arrow 707) which is comparable with or somewhat larger than the dimension of the pixels in the same direction. In this way the different diffracted images from the various pixel types will be generated in sequence to produce a smooth animation effect.

Hence the surface 700 incorporates the animation sequence in the form of a series of diffractive pixels recorded across the surface, where each pixel produces a “frame” in the animation sequence. By generating these “frames” in sequence, the desired animation effect is produced at the viewing screen 404. In FIG. 12 each frame is recorded as a column of pixels, and the animation effect in the diffracted images is produced by moving a specified beam of light across the surface 700 in a direction approximately perpendicular to the columns of pixels, thereby generating the animation frames in sequence at the viewing screen 404. It should be appreciated, however, that other layouts of pixels on the surface 700 are possible. For example, each frame in the animation sequence could be recorded as a single pixel, so that a single row of pixels produces an animation effect. An overall animation sequence could in this way be recorded in a matrix of pixels as a series of such rows of pixels. In this way the overall animation sequence could be played back by moving the spot of light 702 along one row of pixels, then along the adjacent row, and so on until all pixels in the matrix have been scanned. It should also be appreciated that an animation sequence could consist of as many frames as desired—for example a 30 frame sequence, or a 300 frame sequence, or a 3000 frame sequence, may be recorded in the surface 700. It should also be appreciated that the above described movement and intensity animation effects may both be incorporated into an animation sequence using the method described herein.

1. A layer having a diffraction surface to provide one or more diffracted light beams when illuminated by a reading light beam, said surface including first surface area portions dispersed with second area portions, said surface having a base plane with said first area portions being spaced from said base plane by a distance different to that of the second area portions, the first area portions also having a width extending generally parallel to the plane of the diffraction surface, which width is less than the wavelength of the reading light beam, and wherein when illuminated, the diffraction beam produced will provide a recognisable image on an intercepting surface.

2. The layer of claim 1, wherein said first area portions are spaced from said base plane by a greater distance than said second area portions, and said layer is generally planar.

3. The layer of claim 1 or 2, wherein said first area portions are curved so as to be convex.

4. The layer of claim 1, 2 or 3, wherein said first area portions are ridges adjacent to said second area portions, and said width extends between ridges on opposite sides of the second area portion therebetween.

5. The layer of any one of claims 1 to 4, wherein the surface is substantially uniformly optically reflective or uniformly optically transmissive.

6. A method of producing a diffraction pattern including a diffraction grating, the pattern when illuminated producing a recognisable image on a surface intercepting the diffracted light, said method including the steps of:
providing a data stream indicative of the image;
processing the data to determine the configuration of said grating and therefore said pattern, with a characteristic of the processed data corresponding to a physical characteristic of the grating;
providing a plate having a surface to be deformed to have a configuration corresponding to said pattern;
deforming the plate surface in accordance with said data so as to produce said configuration; and wherein
a physical dimension of the grating is determined by said characteristic, and said grating includes a plurality of surface portions from which the light is diffracted to form said image, said surface portions being distributed over the plate surface so as not to be substantially concentrated.

7. The method of claim 6 wherein the step of processing the data includes obtaining a Fourier Transform of the data stream.

8. The method of claim 7 wherein said Fourier Transform is a fast Fourier Transform.

9. The method of claim 7 or 8, wherein said image is divided into a number of pixels or elements which are used to provide said data stream.

10. The method of claim 7, 8 or 9, wherein the surface of said plate is substantially uniformly optically reflective or uniformly optically transmissive.

11. The method of any one of claims 7 to 10, wherein data of said data stream is digitised.

12. The method of claim 11, wherein processing the data stream by a Fourier Transform includes introducing a random number phase sequence to the data.

13. The method of claim 11 or 12, wherein processing the data stream by a Fourier Transform includes clipping the data.

14. The method of any one of claims 6 to 13, wherein said diffraction surface is a master surface from which copies are made, and said method further includes the steps of:
providing further surface to which a copy of said master surface is to be applied;
applying the copy to further surface; and wherein said further surface is substantially uniformly optically reflective or uniformly optically transmissive.

15. The method of any one of claims 6 to 14, wherein the step of providing said data stream includes providing symmetrical images of the recognisable image, the symmetrical images being symmetrical about two perpendicular axes.

16. The method of any one of claims 1 to 15, wherein said step of producing said data stream includes quantising the data stream.

17. A method of producing a diffraction pattern including a diffraction grating. the pattern when illuminated producing a recognisable image on a surface intercepting the diffracted light, said method including the steps of:
providing a data stream indicative of the image;
processing the data to determine the configuration of said grating and therefore said pattern, with a characteristic of the processed data corresponding to a physical characteristic of the grating;
providing a plate having a surface to be deformed to have a configuration corresponding to said pattern;
deforming the plate surface in accordance with said data so as to produce said configuration: and wherein
said configuration includes first area portions and second area portions, with the width of said first area portions bieng less than the wavelength of light.

18. The method of claim 17, wherein said configuration includes ridges having a width, with said physical dimension being said width.

19. A diffraction grating occupying a surface having a first portion spaced from a second portion, with said first portion being configured so that when illuminated a first image is produced on a receiving surface by light diffracted from said first surface, said second surface portion being configured so that when illuminated a second image is produced on said receiving surface by light diffracted from said second portion, the surfaces being configured so that said second image is an alteration of said first image so that when said first portions and second portions are illuminated by a light beam moving from said first portion to said second portion, the change occurs in said first image to produce said second image.

20. The diffraction grating of claim 19, further including one or more intermediate surface portions, located between said first portion and said second portion to produce successive changes in the image as the surface portions are sequentially illuminated as the light beam moves from said first portion across the intermediate or intermediate portions to said second portion.

21. A layer having a diffraction surface, said surface comprising:
first area portions;
second area portions surrounded by and generally separated by the first area portions so as to produce a grid; and wherein
said second area portions have a width extending generally parallel to the surface, so that corresponding portions of parallel adjacent first area portions are spaced about 0.3 to about 2.0 times the wavelength of a reading light.

22. The layer of claim 21, wherein the parallel adjacent first area portions are spaced about 0.5 to about 1.5 times the wavelength of light.

23. The layer of claim 21 or 22, wherein said surface has a base plane with said first area portions being spaced from said base plane by a distance different to that of said second area portions.

24. The layer of claim 23, wherein said first area portions have a dimension extending generally parallel to the plane of the diffraction surface, which first area dimension is less than the wavelength of light.

25. The layer of claim 24, wherein said first area portions are spaced from said base plane by a greater distance than said second area portions, and said layer is generally planar.

26. The layer of claim 24 or 25, wherein said first area portions are curved so as to be convex.

27. The layer of any one of claims 19 to 26, wherein the surface is substantially uniformly optically reflective or uniformly optically transmissive.

28. A diffraction grating occupying a surface having a first portion spaced from a second portion, said first portion being configured so that when illuminated a first image is produced on a receiving surface by light diffracted from said first portion, said second portion being configured so that when illuminated a second image is produced on said receiving surface by light diffracted from said second portion; and wherein said surface has an intermediate portion configured so that when illuminated by a light beam moving from a first portion illuminating said first portion to a second portion illuminating said second portion, an intermediate image is produced on said receiving surface, by light diffracted from said intermediate portion, said intermediate image being initially a transformation of said first image which changes to a transformation of said second image as said beam approaches said second portion.
